(19) United States
(12) Patent Application Publication
(10) Pub. No.: US 2005/0177534 A1
(43) Pub. Date: Aug. 11, 2005

(54) Information management system and methods therein

(76) Inventor: Lars Brorsson, Kulladal (SE)

Correspondence Address: BIRCH STEWART KOLASCH & BIRCH, PO BOX 747, FALLS CHURCH, VA, 22040-0747, US

(21) Appl. No.: 10/512,693

(22) PCT Filed: Apr. 30, 2003
(86) PCT No.: PCT/SE03/00704

(30) Foreign Application Priority Data
May 2, 2002 (SE) 60376839

(51) Int. Cl. G06F 7/00

(52) U.S. Cl. 707/1

(57) ABSTRACT

Methods, in an information management system, for addressing and transmitting a handwritten message to at least one recipient using an electronic address book. In the electronic address book a short address is associated with at least one recipient, and, thus, with at least one complete receiving address of a recipient. When addressing a message written by a digital pen on a position-coded product, only the short address of the intended recipient(s) needs to be written on the product, instead of the complete address(es) of the recipient(s). The electronic address book is implemented in the digital pen used in the information management system and/or in a database of the system.

### FIELD OF THE INVENTION

The present invention generally relates to the field of digital communication, and more specifically to methods for addressing and transmitting a message to at least one recipient. The invention further relates to a computer readable medium comprising instructions for bringing a computer to perform such methods, and an information management system.

### BACKGROUND OF THE INVENTION

In the international application WO 01/16691, which is incorporated herein by reference, the use of a product having a writing surface which is provided with a position code is envisaged. The position code, which codes a plurality of positions on the surface, enables electronic recording of information that is being written on the writing surface, by means of a digital pen which detects the position code.

The above-concept can be used for a number of different purposes. The combination of pen and position-coded product can be used as an input device to a computer, a PDA, a mobile phone or the like. For example, text and sketches written on a position-coded notepad can be transferred via the pen to a computer. The combination of pen and position-coded product may also allow for global communication, directly from the product via the pen, by the position code on the product being dedicated for such communication.

Different areas on the product can be allocated different functions, by the positions coded within each such active area being associated with a specific processing instruction. For example, a text written on the position-coded product can be registered by the pen and transformed to a fax message, an e-mail or an SMS, and then be sent from the pen to a recipient. When addressing such a message, the address is typically written by hand in an address area provided on the position-coded product using the pen. The handwritten address is thus registered by the pen as a sequence of positions. The sequence is then digitally interpreted, based on the processing instruction(s) associated with the positions of the sequence, by the pen or by a sending device having a similar functionality as the pen, and, then, the message is addressed with the digitally interpreted address. At present, Intelligent Character Recognition (ICR) or Handwriting Recognition (HWR) may be employed to perform this digital interpretation.

However, there are a number of problems associated with writing addresses by hand, for example, there may be a risk of misinterpretation of the address when the digital interpretation of the registered address is performed, for example, if a letter and/or a number included in the address are indistinctly written. Furthermore, the user may write the address incorrectly, due to a writing error or because he/she remembers the address incorrectly.

Attempts have been made to eliminate the handwriting of addresses, see for example WO 01/61449 and WO 00/72244.

In WO 01/61449, a system and a method for electronic data entry using an electronic reading device is disclosed. The system comprises pre-printed e-mail forms printed on products provided with a position code including a limited, pre-determined number of shortcut fields. By touching a shortcut field using the reading device, an address can be inserted in an address field of the e-mail form. In this system, each shortcut has a pre-determined number, from 1 to 8, which is printed on the e-mail form. Thereby, the user is required to remember which shortcut number that corresponds to a certain recipient. Furthermore, the user may erroneously touch a shortcut field adjoining the intended field, which will result in that the message is sent to the wrong recipient.

WO 00/72244 discloses a system and a method for composition and transmission of an electronic mail message using a printed address list. The list, which is printed on a product provided with coded data, and includes a predetermined number of pre-printed addresses and an e-mail “button” associated with each pre-printed address. When an e-mail is to be sent, the user touches a specific e-mail button provided on the printed list, using an electronic pen. This results in the printing of a position-coded e-mail form, which is provided with the address associated with the selected e-mail button. The thus-printed form may then be used for writing and sending a message to the selected addresses. According to this system, the user must have access to a printer or carry a printer for to be used each time he/she intends to perform an action, such as sending an e-mail or updating the printed address list.

### SUMMARY OF THE INVENTION

Thus, an object of the present invention to provide a simplified and improved method and system for addressing a message in an information management system.

This and other objects are achieved according to the present invention by proving methods, a computer readable medium, a system and an electronic address book having the features defined in the independent claims. Preferred embodiments are defined in the dependent claims.

For the purpose of clarity, the term full address refers to a receiving address of a recipient, for example, a fax number address, an electronic mail address or a telephone number, e.g. for SMS or MMS messages.

In the context of the present invention, the term “electronic address book” relates to a digitally stored directory or register containing a number of records indicating, for example, electronic mail addresses, telephone numbers, fax numbers, etc.

According to a first aspect of the present invention there is provided a method for addressing a message, intended to be transmitted to at least one recipient, in a system comprising a plurality of products provided with a position code, a plurality of digital pens capable of reading said position code, and a server means communicating with said digital pens in at least one communications network. The inventive method comprises the steps of: providing an electronic address book comprising a plurality of address records, wherein each address record comprises at least one full address and a short address associated with said at least one full address, wherein each full address indicates a receiving address of one of the recipients; receiving an address reference input; receiving an indication input that said address reference input is a short address, wherein said short address is related to a least one recipient; identifying each full address associated with said short address; retrieving said identified full address(es); and addressing said message using said retrieved full address(es).

According to a second aspect of the invention, there is provided a method for transmission of a message to at least one recipient, in a system comprising a plurality of products provided with a position code, a plurality of digital pens capable of reading said position code, and a server means communicating with said digital pens in at least one communications network. The method according to the second aspect of the invention comprises the steps of receiving said message composed on a product provided with a position code using a digital pen, addressing the message using the method according to the first aspect of the invention, and transmitting the message using the digital pen to said at least one recipient.

According to a third aspect of the invention there is provided a computer readable medium comprising instructions for bringing a computer to perform the method according to the first or second aspect of the invention.

According to a fourth aspect of the invention, there is provided an information management system comprising a plurality of products provided with a position code; a plurality of digital pens capable of reading said position code; a server means communicating with said digital pens in at least one communications network, wherein each of the digital pens is arranged to communicate information, which is registered on the products in the form of at least one position which is coded by said position code, to at least one recipient via said server means; and a plurality of electronic address books, each being associated with one of the digital pens, wherein each electronic address book comprises a plurality of address records, wherein each address record comprises at least one full address and a snort address associated with at least one full address, wherein each full address indicates a receiving address of a recipient.

Thus, the present invention is based on the idea of using user inputted short addresses for addressing messages in an information management system as herein described. By relating a user defined short address to at least one full address of a recipient, the addressing of messages is significantly facilitated. Instead of writing the full address corresponding to the receiving address of a recipient, the short address related to the recipient is written.

This solution provides several advantages over the existing solutions. One advantage is that the user inputs the short address by writing with the digital pen. This reduces the risk of addressing the message to the wrong recipient, which is an evident risk with the method disclosed in WO 01/61449 where an erroneous selection of a neighboring shortcut addressing field would send the message to the wrong recipient.

Another advantage is that the user does not need to have access to a printer or carry a printer each time he/she intends to perform an action, such as sending an e-mail or updating the printed address list, which is required in the method according to WO 00/72244. Furthermore, the addressing and sending of a message, for example an e-mail, is simple and fast according to the present invention, as compared to the method disclosed in WO 00/72244. Due to the printer requirement this known method of addressing and sending a message becomes awkward and time-consuming.

An additional advantage is that the risk of the writing recognition technology misinterpreting characters, numbers or letters included in an address is significantly reduced since the stated short address is normally much shorter than the full address. Such misinterpretations occur in particular when the characters are indistinctly written, which is common when an address is written by hand. The result may be that the message is sent to wrong recipient. Accordingly, using short addresses consisting of one or a few characters reduces the risk of misinterpretations in the recognition process performed in the digital pen when there are only one or a few characters to interpret.

Moreover, the short addresses stored within the electronic address book may be used in the interpretation of the short address input by comparison between the short address input and the stored short addresses. Thereby, the risk of misinterpretations in the recognition process is even further reduced.

Furthermore, it is time-consuming to write the full address. This applies, in particular, to electronic mail addresses, which may be both long, i.e. comprise a plurality of characters, and complicated. By using the present invention, the time for entering an address for a recipient of the message is significantly reduced.

In addition, it is necessary for the sender to remember the complete full address of each recipient, which is more difficult the more complicated or longer an address is. In accordance with the present invention, a user only has to remember short and uncomplicated addresses. Thereby, not only is the risk of entering the address wrongly significantly reduced, so too is the time that a user may require for trying to remember a long address or retrieving a forgotten address.

The short addresses may be defined by the user of each digital pen. Thereby, the user is able to define or select a short address that matches or is associated with the recipient, for example, a nick name or an abbreviation. This association may be personal, thus making the short addresses easier to remember by the user.

The electronic address book contains the receiving addresses most frequently used by a user when transmitting messages. Generally, the number of short addresses in the electronic address book is limited. Thus, by remembering a limited number of short addresses, preferably but not necessarily user defined, the user acquires the receiving addresses of the recipients for a majority of the transmitted messages. This is due to the fact that the vast majority of messages a user is likely to transmit, is intended for a limited number of recipients. In fact, studies have shown that 70 percent of sent electronic mail messages are sent to the 10 most frequently used addresses.

Hence, the addressing of a message according to the invention ensures safer and more time-efficient addressing of a message.

The short address may be stated or written in a specific address area provided on said position-coded product using said digital pen. The specific address area may contain one or more pre-defined writing positions defined by lines, boxes or combs, wherein each pre-defined writing position is intended for one character.

The specific address area may be designated or reserved for a short address. The position-coded product may comprise a number of different areas, each being designated for a specific purpose. By stating, for example, a text or a character in the specific address area, the text or the character is interpreted as a short address by the system, for example by the digital pen, when the short address is being inputted into the system.

Alternatively, the specific address area may be arranged for receiving either a short address or a full address. Then, the system will have to identify or realize whether the input in the area is a short address or a full address. This may be achieved by providing the position-coded product with a specific indicator area or box for indicating, by using the digital pen, that the address reference written in the specific address area is indeed a short address. This can be done by marking the indicating area when a short address is stated, and by leaving the area empty when a full address is stated, or vice versa.

According to one exemplifying embodiment of the invention, the system distinguishes between a short and a full address, that is stated as an address reference in the specific address area arranged for receiving either a short address or a full address, by performing a comparison of the address reference, read by the digital pen, with the short addresses stored in the electronic address book. If a match occurs, the address reference is interpreted as a short address. When a match occurs, an indication may be provided by the digital pen in order to notify the user that a successful match has occurred. This indication may be in the form of an optical or audible signal or a vibration, or any other type of signal conceivable by the skilled person.

Each address record of the electronic address book may comprise a full address field arranged to hold or store a full address, and a short address field arranged to hold or store a short address associated with the full address.

In one embodiment, a number of full addresses may be associated with one and the same short address. There is often a need to transmit a message to a number of recipients at the same time, which is time-consuming because each full address has to be written. Also, the risk of errors is further increased. Thus, the present invention allows for even more facilitated and simplified addressing of messages. Instead of writing a number of full addresses, each being associated with the receiving addresses of one of the recipients, only one short address needs to be written.

The address record may further comprise a group address field arranged to hold or store a group reference. The group reference may be inputted when the user wants to send a message to an entire group, i.e. a number of recipients. Thus, the system treats the group reference as a short address, and the message is addressed to all full addresses associated with the inputted group reference.

Furthermore, each address record may comprise an address type field associated with a full address field and arranged for holding an address type reference. The address type reference indicates the address type of the full address in said full address field. Thereby, the address type of a full address may be obtained as soon as the full address is identified. As mentioned above, examples of different address types are electronic mail addresses, fax addresses, SMS addresses and MMS addresses. SMS (Short Messaging Service) is a messaging service that allows for a user to transmit text to a mobile phone and MMS (Multimedia Messaging Service) is a messaging service that allows for a user to, in addition to text, transmit, for example, pictures or drawings to a mobile phone. As understood by the person skilled in the art, the present invention is not restricted to these message types. On the contrary, any type of message that is possible to compose and transmit with a system of the above-mentioned type is within the scope of the present invention.

According to another embodiment, the address record comprises at least one additional full address field, each arranged to hold or to store a full address. Accordingly, it is possible to include a number of full addresses in a single address record. Each full address may have an address type reference indicating the address type, as described above. Thereby, a single short address may be associated with a number of full addresses and by stating such a short address on a message, the message will be sent to all the full addresses associated with that short address.

According to one embodiment, the server means includes an interface unit by means of which users in said system are allowed to enter information into and retrieve data from one or more databases of said system. The interface unit may connect at least one portal with the databases, thereby allowing the pen owners, i.e. the pen users, to access selected portions of the databases. The above-mentioned portal may be implemented on an Internet-connected server providing a GUI (Graphical User Interface) to the users via the Internet. It should be noted, however, that Internet is representative of a preferred use of the present invention, but should not be considered limiting, as the invention could apply in other networks or combinations of networks.

Preferably, the electronic address book is associated with or related to the digital pen and not the user. Thereby, the pen owner or pen user can access and use the electronic address book without the need for transmitting address information or address data between components in the system, which reduces the load of the system.

The plurality of electronic address books may be stored or held by a database of the system. The pen owners or the users can access the portal by means of, for example, a web browser on any suitable device, such as a mobile phone. By means of the interface unit, via the portal, the pen owners are able to view, change and/or add settings related to their digital pen. Accordingly, they can perform changes of the information held by the electronic address book related to or associated with their pen, or in other words, edit the electronic address book related to their pen. For example, add a new full address or change the short address associated with a full address.

Alternatively or additionally, each digital pen may comprise an electronic address book, which may be stored in a memory or storage means of the digital pen.

Each digital pen may further comprise means for enabling a user to perform changes of the information held by the electronic address book contained in the digital pen.

The information comprised in the electronic address book may be provided in a physical address book or address book page embodied as a position-coded product. Consequently, a physical address book page may comprise the items or records of the electronic address book, and designated areas corresponding to the respective field of the address records in the electronic address book.

The physical address book page may be used for changing the information held by the electronic address book, i.e. for editing the electronic address book, using the digital pen with which the electronic address book is associated. Preferably, the physical address book page comprises empty areas into which new address items, i.e. short addresses and/or corresponding full addresses, may be entered.

As realized by the person skilled in the art, the methods of the present invention, as well as embodiments thereof, may be realized or implemented as a computer program on a computer readable medium, or as application-specific hardware, preferably within the contents of a digital pen.

Further objects and advantages of the present invention will be discussed below by means of exemplifying embodiments.

### BRIEF DESCRIPTION OF THE DRAWINGS

Preferred embodiments of the invention will now be described in greater detail with reference to the accompanying drawings, in which

FIG. 1 shows an embodiment of an information management system, including an interface unit, according to the present invention;

FIG. 2 schematically shows an embodiment of a product provided with a position code;

FIG. 3 schematically shows an embodiment of a digital pen according to the present invention;

FIGS. 4-6 show three different embodiments of an electronic address book according to the present invention;

FIGS. 7-12 show different embodiments of a position-coded product intended for messages;

FIG. 13 is a generic flow chart of the actions performed in the system of FIG. 1 when a digital pen is operated on the position-coded products of FIGS. 7-12; and

FIG. 14 shows a print-out of an address book according to an embodiment of the invention.

### DESCRIPTION OF PREFERRED EMBODIMENTS

In the following, there will be disclosed preferred embodiments of an information management system comprising a plurality of position-coded products, a plurality of digital pens, a server communicating with the digital pens in at least one communications network, and a plurality of electronic address books, wherein each electronic address book is related to or associated with a digital pen.

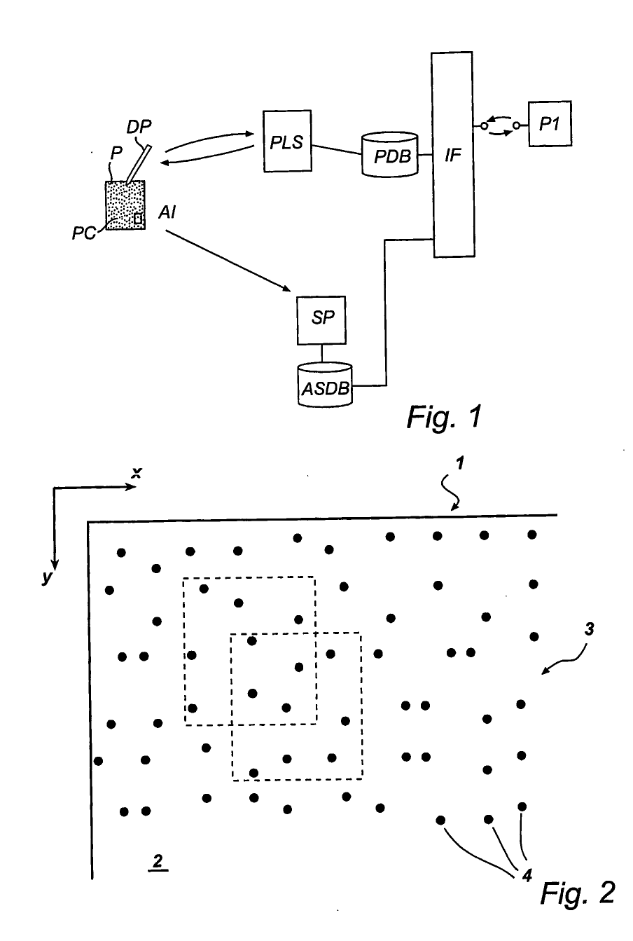

FIG. 1 shows an information management system in which a position-coded product and a sending device, such as a digital pen, can be integrated. Such a system or infrastructure is described in detail in Applicant's international patent publications WO 01/48678, WO 01/48591, and WO 01/48685, which are incorporated herein by reference.

The system of FIG. 1 includes a multitude of digital pens DP and products P (only one of which being shown in FIG. 1) provided with a position code PC, and a central server unit PLS. The central server unit PLS may be connected to a pen database PDB, which includes data on all digital pens in the system. The central server unit PLS can be arranged to communicate with the pens DP in order to receive position data therefrom and process the data according to pre-stored instructions. Alternatively, the central server unit PLS may be arranged to receive position data from the digital pens DP, retrieve a network address associated with the received position data, and return the network address to the respective digital pen DP. The pen DP may then send suitable position data for processing by a service provider unit SP, typically a server, at the network address. The service provider unit SP can, for example, provide for network storage of information generated in the system, e.g. an electronic address book according to the present invention or entries in a position-coded calendar or notebook.

It should be noted that information can be transmitted in any suitable way from the digital pen DP to the central server unit PLS. For example, wireless transmission of information may be effected from the digital pen DP to a network connection unit (not shown), which in turn may transmit the information to the central server unit PLS.

The system also includes one or more networks in which network operators handle the communication between the digital pens DP, the central server unit PLS, and optionally the service provider unit SP.

The system of FIG. 1 also includes one or more Internet portals P1 hosted by one or more web servers which are interfaced, by means of an interface unit IF, with one or more databases of the system. The structure and operation of the interface unit IF is described in detail in Applicant's international patent publication WO 02/075629, which is incorporated herein by reference.

From the portal P1, pen owners are able to view, change and/or add settings associated with the owner's digital pen, for example address book information, as will be further discuss below. These settings may be stored in the pen database PDB, an application database ASDB associated with the service provider unit SP, or in the pen itself.

FIG. 2 shows a portion of a position-coded product, corresponding to the product P in FIG. 1, in the form of a paper 1, provided with an optical readable position code 3 on its surface 2, which enables determination of positions. The position code includes markings 4, which are methodically arranged over the surface 2. A group of markings (within a detection window as indicated by dotted lines in FIG. 2) collectively code a position. The structure of the position code is further described in Applicant's international patent publication WO 01/26032, which is incorporated herein by reference.

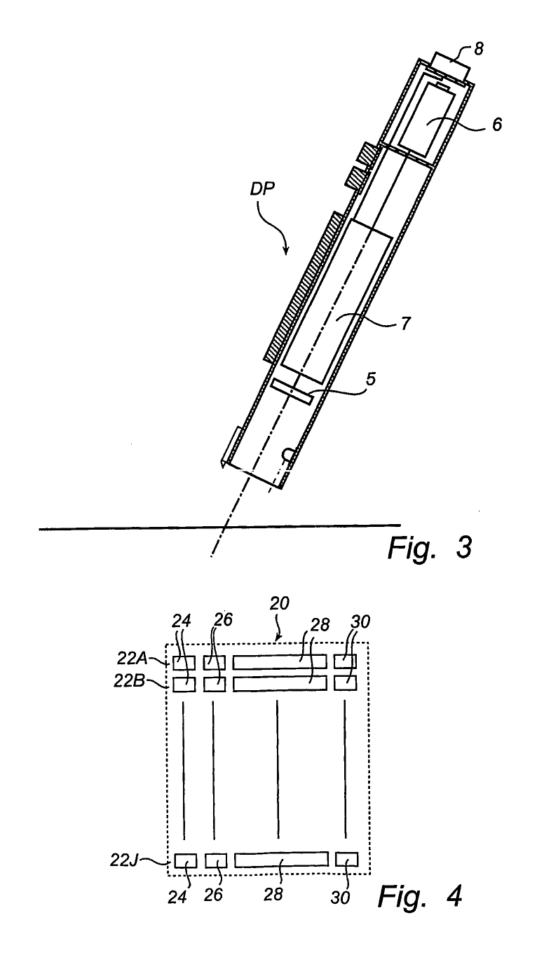

FIG. 3 shows a schematic representation of a digital pen DP designed for reading a position code. The pen comprises a light-sensitive area sensor 5, a power supply 6, an electronic unit 7, and a transmission unit 8 for wired or wireless transmission of data to an external device, such as a mobile phone, PDA, PC, etc. The electronic unit 7 comprises a processor device including an image processor which is programmed and/or designed to read images from the area sensor 5, and perform position determination and, optionally, interpretation of the resulting position data, for example based on algorithms for ICR or HWR, which are known in the art. The algorithms for position determination are described in detail in Applicant's international patent publications WO 01/26033, WO 03/001440, and WO 03/001441, which are incorporated herein by reference.

The electronic unit 7 also comprises a memory or data storage (not shown), which may be arranged to store data received from the image processor or the area sensor, as well as program instructions for the image processor. The memory may also be arranged to store an electronic address book according to the present invention. Further, the electronic unit 7 may comprise interface circuitry (not shown), which enables the pen owner to perform changes to the information held by the memory, typically by operating a keypad and a display on a peripheral unit associated with the pen, such as a mobile phone, a PDA or a computer.

FIGS. 4-6 show the principal structures of three embodiments of an electronic address book according to the invention. The electronic address book can be stored either in the memory of the digital pen or in a database of the system, for example, the pen database. Preferably, an electronic address book is related to a specific digital pen rather than to a specific pen owner, independently of where the electronic address book is implemented.

The electronic address book 20 of FIG. 4 contains 10 address records 22A-22J, wherein the first two address records 22A, 22B and the tenth address record 22J are shown in FIG. 4. A typical number of address records is, for example, 10-20. In all embodiments, this number can be expanded to meet the needs of the pen owner, with the maximum number of address records being limited by the allocated storage capacity. Each address record 22A-22J is arranged for a receiving address of a recipient. Furthermore, each address record 22A-22J includes accommodations for: a short address 24; a group reference 26; a full address 28; and an address type reference 30. In this embodiment, all information held by an address record is user defined. Each short address is related to or associated with a full address, and, thus, a recipient. The short address may consist of an arbitrary number of characters, for example only numbers, only letters, or combinations thereof. Drawn figures may also be used as short addresses, such as a smiley or a heart (as written on the product in FIG. 11). Drawn figures may also be used to represent Asian signs or characters. In other words, user-defined or user-designed short addresses are allowed.

A full address is a receiving address of a recipient, wherein the receiving address may be an electronic mail address, a fax number or a telephone number, e.g. for an SMS message or an MMS message. Accordingly, the full address may include letters, numbers or combinations thereof, such as may be the case for an electronic mail address. The address type reference indicates the message type, i.e. if the full address is an electronic mail address, a fax number or a telephone number, e.g. for an SMS message or an MMS message. For example, the letter ‘e’ may denote an electronic mail message, the letter ‘f’ a fax message, the letter ‘s’ an SMS message, and the letter ‘m’ an MMS message. Thus, the address type reference allows the system to easily distinguish between different address types, for example, between an SMS address and an MMS address or between an SMS address and a fax number.

The group reference indicates whether or not a recipient in the electronic address book is included in a group, i.e. a group is a collection of full addresses for a number of recipients. Thus, when the user intends to transmit the same message to a number of recipients, he or she transmits it to the group including these recipients. The combination of a letter and a number, e.g. ‘G1’, may denote a group (as written on the product in FIG. 12). A group may comprise an arbitrary number of full addresses. Furthermore, a group is not limited to only electronic mail addresses. On the contrary, a group may comprise a mix of different types of addresses. This means that the same message can be sent to a number of recipients simultaneously, i.e. to all the recipients comprised in the group used for addressing the message, wherein the recipients may have different types of receiving addresses. Of course, an address of a specific recipient may be included in several groups.

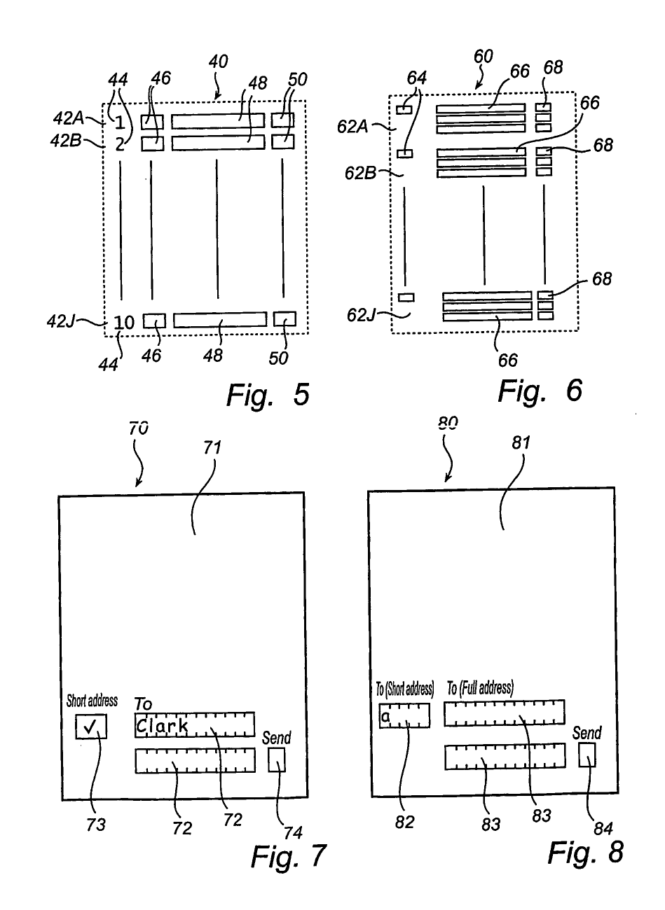

In FIG. 5, the electronic address book 40 includes 10 address records 42A-42J, each of which including accommodations for: a short address 44; a group reference 46; a full address 48; and an address type reference 50. In this embodiment, the short addresses are predefined. The short address may be numbered from 1 up to the number of included address records, which in this case is 10.

In FIG. 6, the electronic address book 60 includes 10 address records 62A-62J, each of which including accommodations for: a short address 64; three full addresses 66; and three address type references 68. Thus, each short address is related to three receiving addresses, although the address book may be designed to accommodate for any other number full addresses associated with each short address. Again, an address record may comprise a combination of different types of addresses.

FIGS. 7-12 illustrate specific embodiments of a position-coded product intended for messages. The product is provided with a number of different active areas or boxes. As discussed above, the built-in functionality of the position-coded products allows each active area provided on such a product to be dedicated to or reserved for a specific function.

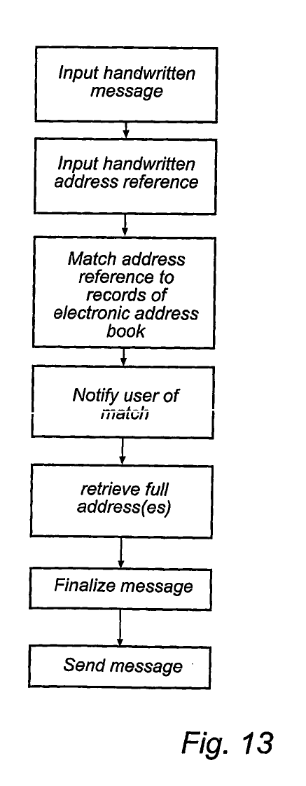

FIG. 13 is a generic flow chart illustrating the actions performed in the system of FIG. 1 when a digital pen is operated on the position-coded products of FIGS. 7-12. Generally speaking, the procedures of addressing and transmitting a composed message may be executed in the pen, in a peripheral unit associated with the pen, in the central server unit, in the service provider unit, or may be distributed between two one more of these units.

In FIG. 7, the position-coded product 70 comprises a writing area 71 which is intended for the composing of a message. The message can, for example, consist of hand-written text or hand-drawn images. Further, a universal address area 72 is provided on the product 70. The address area 72 is arranged for a user to state or write an address reference in the address area 72, which may be either a short address or a full address.

The procedures of composing, addressing and transmitting a message, when a product or the type described with reference to FIG. 7 is used, are as follows. First, a message is composed by writing a text and/or drawing a figure by hand, using a digital pen, on the writing area 71 of the product 70. Thereby, the message is inputted into the system. In the following, unless provisions to the contrary are contained, it is premised that each time the pen is used to write or draw anything, for example a text or a figure, on a position-coded product, the text or the figure is inputted into the system. Then, also by using the pen, the short address, or, more correctly, the address reference, related to the intended recipient or recipients is stated in the address area 72 (‘Clark’ in FIG. 7). Subsequently, the indicator area 73 is marked using the digital pen. This constitutes an indication that the address reference is a short address, and the system will handle the inputted address reference as a short address. As a result, the system will perform a matching or comparing procedure using the inputted short address, in which the inputted short address is matched with the short addresses (including group references) of the electronic address book. When a match occurs, the system will identify each full address associated with the short address from the electronic address book. Also, when a match occurs, an indication, for example an optical, audible, or a vibrating signal, may be provided by the digital pen in order to notify the user that a match has occurred. Thereafter, each identified full address is retrieved from the electronic address book and is used to address the message. The composed message is then sent after the recording of at least one position from a send area 74 on the product 70. It should perhaps be emphasized that group references are treated as a class of short addresses in the procedure of addressing a message.

In a variant of the above embodiment, the system is able to identify an address reference written in the address area 72 as a short address without any further pen owner input. In other words, the indicator area 73 may be omitted. In this case, the system may compare the inputted address reference with the short addresses (including group references) of the electronic address book and if there is a match, the address reference is handled as a short address by the system.

To avoid reiterations, the following description of the products in FIGS. 8-12 is focused on differences with respect to the product in FIG. 7.

FIG. 8 shows a second embodiment of a position-coded product. The product 80 comprises a writing area 81, a short address area 82 dedicated for a short address, a full address area 83 dedicated for a full address, and a send area 84. The short address area 82 is subdivided into five writing positions, each dedicated for receiving a respective character. As an example, a short address ‘a’ is written in the short address area 82. The number of writing positions may vary between different embodiments. For example, the electronic address book in FIG. 5 only necessitates two writing positions, since the short addresses are made up of not more than two characters.

The procedures of composing, addressing and transmitting a message differ from the procedures described with reference to FIG. 7 in that the address reference is stated in the short address area 82, instead of in the universal address area (72 in FIG. 7).

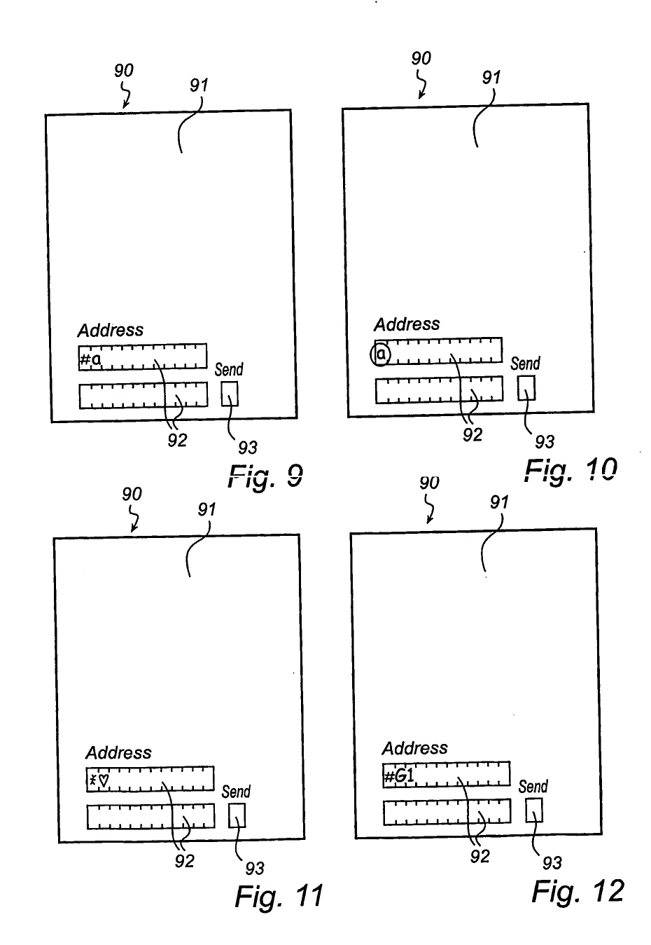

FIGS. 9-12 shows a third embodiment of the position-coded product according to the invention. The product 90 has a writing area 91, a universal address area 92 and a send area 93. The procedures of composing, addressing and transmitting a message differ from the procedures described with reference to FIG. 7 in that an indicator is stated in the address area 92 together with the address reference. Thereby, the system will be able to identify and handle the address reference as a short address. If the address reference is stated without the indicator, the system will try to interpret the stated address reference as a full address. In FIG. 9, the indicator is exemplified as the character ‘#’ and the address reference is exemplified as the letter ‘a’. In FIG. 10, the indicator is instead a ring encircling the address reference ‘a’. For the encircling to be detected as an indicator, it may or may not need to have a dedicated shape. In FIG. 11, there is shown a further example of an indicator ‘*’, and a further example of a graphical address reference, a heart, which are both written in the address area 92. In FIG. 12, a further example is shown, wherein a group reference ‘G1’ and an indicator ‘#’ are written in the address area 92.

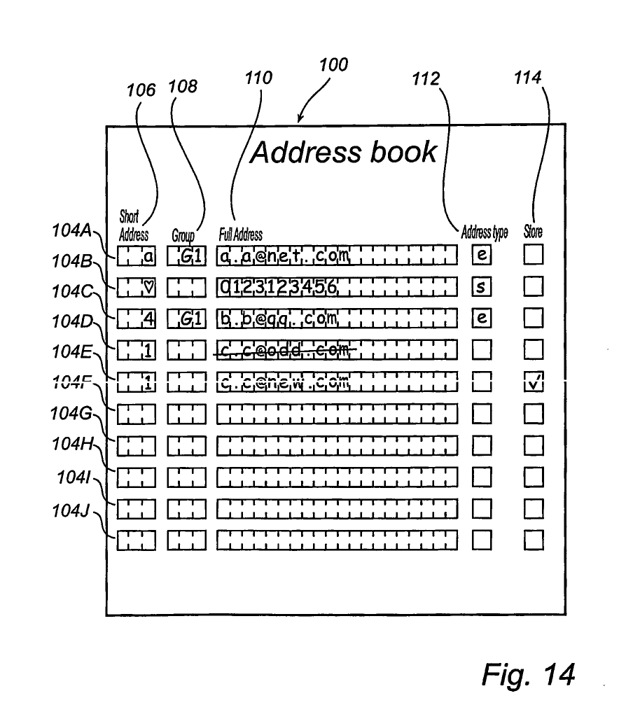

The electronic address books in FIGS. 4-6 may also be provided as a position-coded product, such as the product described with reference to FIG. 2. For example, the pen owner may create a position-coded product by printing the electronic address book, e.g. using a printer via a computer connected to the system. In FIG. 14, a print-out 100 of the electronic address book described with reference to FIG. 4 is shown in the form of an address book page. Accordingly, the electronic address book page 100 comprises a number of address records 104A-104J each comprising: a short address area 106; a group area 108; a full address area 110; and an address type area 112. Additionally, a store area 114 is included for each address record 104. The number of writing positions of each area is only for illustrative purposes, and may vary among different embodiments of the electronic address book.

By way of example, some short addresses with their corresponding full addresses are shown in the address records 104A-104C of FIG. 13. The address record 104A comprises a short address ‘a’, a group reference G1, a full address ‘a.a@net.com’ and an address type reference ‘e’. The group reference ‘G1’ denotes that the short address ‘a’ is included in a group denoted G1 and the address reference ‘e’ denotes that the full address ‘a.a@net.com’ is an e-mail address. Furthermore, the address record 104B includes a graphical short address in the form of a heart, a full address ‘0123123456’ and an address type reference ‘s’. In this case, the full address is a SMS address, or in fact a mobile phone number, indicated by the address type reference ‘s’. The address record 104C includes a short address ‘4’, a group reference G1, a full address ‘b.b@qq.com’ and an address type reference ‘e’. Here, the group reference ‘G1’ denotes that the short address ‘4’ also is included in the group denoted G1 and the address reference ‘e’ denotes that the full address ‘b.b@qq.com’ is an e-mail address.

The address book page may be used for editing the electronic address book. For example, the user may exchange the full address associated with a specific short address. By crossing out a full address in a full address area associated with the specific short address, using the digital pen, the user deletes the full address. This is illustrated in the address record 104D. In this case, the specific short address is ‘1’ and the crossed out full address ‘c.c@old.com’. Then, again by using the pen, the user may insert a new full address by writing the new full address in an empty full address area 108 and associate the specific short address with the new full address by writing the specific short address in the short address area of the empty address record, which is illustrated in the address record 104E. Here, the new full address is ‘c.c@new.com and the short address is ‘1’, i.e. the same as in address record 104D. Finally, the user, by marking the store area of the address record, stores the new information in the electronic address book. According to another alternative, a full address is exchanged simply by writing the new full address in an empty address record, and by writing the specific short address, associated with the old full address, in the short address field of the new full address. Thereafter, the store area is marked.

As stated above, the electronic address book may be stored in the memory of the pen. This means that the pen owner has access to the electronic address book directly, without any connection to the networks of the system. In addition to the above-mentioned ways of operating the pen on a print-out for changing the address book information, the pen owner may be allowed to edit the contents of the electronic address book by using a keypad and a display of an peripheral unit associated with the pen, such as a mobile phone, a PDA or a personal computer. For example, the user may via the peripheral unit command an uploading of the electronic address book from the memory in the pen, and, after editing, command a downloading of the electronic address book back into the pen memory.

Alternatively or additionally, the electronic address book may be stored in a database of the system, for example, in the pen data base. The interface unit IF (FIG. 1) then provides access to the pen database PDB via an Internet-based web site, such as the portal P1. The portal P1 may thus allow the pen owner to change the contents of the electronic address book using a keyboard and a display of any suitably network-enabled unit, such as a computer, mobile phone, PDA, etc. The portal P1 may also allow the pen owner to print a position-coded address book form.

The system may be arranged to sense any changes in the pen database PDB, and, if the electronic address book is stored in the pen, to send any updated or new address book information to the pen the next time it connects to the central server unit PLS. Since the address book information is updated through the interface unit IF, synchronization conflicts are avoided.

The foregoing description of an implementation of the invention has been been presented for the purposes of illustration and description. It is not exhaustive and does not limit the invention to the precise form disclosed. Modifications and variations are possible in light of the above teachings or may be acquired from practicing the invention.

1. A method for addressing a message, intended to be transmitted to at least one recipient, in a system comprising a plurality of products provided with a position code, a plurality of digital pens capable of reading said position code, and a server means communicating with said digital pens in at least one communications network, said method comprising the steps of:
providing an electronic address book comprising a plurality of address records, wherein each address record comprises at least one full address and a short address associated with said at least one full address, wherein each full address indicates a receiving address of one of said recipients,
receiving an address reference input,
receiving an indication input that said address reference input is a short address, wherein said short address is related to a least one recipient,
identifying each full address associated with said short address,
retrieving said identified full address(es), and
addressing said message using said retrieved full address(es).

2. The method according to claim 1, wherein said steps of receiving comprise the step of obtaining address reference input from a specific address area provided on said position-coded product.

3. The method according to claim 2, wherein said specific address area is reserved for a short address.

4. The method according to claim 2, wherein said specific address area is reserved for an address reference that is either a short address or a full address.

5. The method according to claim 2, wherein the step of receiving an address reference input further comprises the step of obtaining a marking input from a specific indicator area provided on said position-coded product, wherein said marking input denotes that the received address reference input is a short address.

6. The method according to claim 2, wherein the steps of receiving comprise the step of obtaining an indication input from said specific address area that the address reference input is a short address.

7. The method according to claim 6, wherein the step of obtaining an indication input comprises the step of receiving an indicator, wherein said indicator denotes that the inputted address reference is a short address.

8. The method according to claim 7, wherein said indicator is an encircling of at least part of the address reference, wherein said encircling denotes that the address reference is a short address.

9. The method according to claim 7, wherein said indicator is a graphical symbol.

10. The method according to claim 7, wherein said indicator is a specific character or a combination of specific characters.

11. The method according to claim 1, wherein said short address comprises at least one character.

12. The method according to claim 1, wherein said short address comprises at least one letter.

13. The method according to claim 12, wherein said short address is constituted by a word, preferably a name.

14. The method according to claim 1, wherein said short address comprises at least one digit.

15. The method according to claim 1, wherein said short address comprises a graphical symbol.

16. The method according to claim 1, wherein each address record comprises a full address field arranged for holding a full address, and a short address field arranged for holding a short address associated with said full address.

17. The method according to claim 16, wherein each address record further comprises a group address field arranged for holding a group reference, wherein said group reference indicates that said full address is included in a recipient group, wherein the step of receiving an address reference input comprises the step of receiving a group reference input.

18. The method according to claim 16, wherein each address record further comprises at least one additional full address field, each being arranged for holding a full address.

19. The method according to claim 16, wherein each address record further comprises an address type field associated with a full address field and arranged for holding an address type reference, wherein said address type reference indicates the address type of the full address in said full address field.

20. The method according to claim 19, wherein the address type is an electronic mail address, a fax address, an SMS address or an MMS address.

21. The method according to claim 1, further comprising the steps of receiving instructions via said digital pen for performing changes to the information held by the electronic address book, and performing said changes, wherein each of said plurality of digital pens comprises means for performing said changes.

22. The method according to claim 1, wherein said server means includes an interface unit by means of which users in said system are allowed to enter information into and retrieve data from one or more databases of said system, wherein the method further comprising the steps of receiving instructions via said interface unit for performing changes of the information held by the electronic address book, and performing said changes to the information held by an electronic address book associated with a digital pen in accordance with instructions inputted by a user using said interface unit.

23. The method according to claim 1, wherein said short address is user defined.

24. A method for transmission of a message to a least one recipient, in a system comprising a plurality of products provided with a position code, a plurality of digital pens capable of reading said position code, and a server means communicating with said digital pens in at least one communications network, said method comprising the steps of
receiving said message composed on a product provided with a position code using a digital pen,
addressing said message using the method according claim 1, and
transmitting said message to said at least one recipient.

25. A computer readable medium comprising instructions for bringing a computer to perform a method according to claim 1.

26. An information management system comprising
a plurality of products provided with a position code,
a plurality of digital pens capable of reading said position code,
a server means communicating with said digital pens in at least one communications network, wherein each of said digital pens is arranged to communicate information, which is registered on said products in the form of at least one position which is coded by said position code, to at least one recipient via said server means, and a plurality of electronic address books, each being associated with one of said digital pens, wherein each electronic address book comprises a plurality of address records, wherein each address record comprises at least one full address and a short address associated with at least one full address, wherein each full address indicates a receiving address of a recipient.

27. The system according to claim 26, wherein each of said digital pens comprises one of said plurality of electronic address books.

28. The system according to claim 26, wherein a database of said system comprises said plurality of electronic address books.

29. An electronic address book for an information management system, said system comprising a plurality of products provided with a position code, a plurality of digital pens capable of reading said position code, and a server means communicating with said digital pens in at least one communications network, wherein each of said digital pens is arranged to communicate information, which is registered on said products in the form of at least one position which is coded by said position code, to at least one recipient via said server means, wherein said electronic address book comprises a plurality of address records, each address record comprising at least one full address and a short address associated with said at least one full address, wherein each full address indicates a receiving address of a recipient, and wherein said electronic address book is associated with one of said digital pens.

30. The electronic address book according to claim 29, wherein said electronic address book is contained in its associated digital pen.

31. The electronic address book according to claim 29, wherein said electronic address book is contained in a database of said system.
